(19) United States
(12) Patent Application Publication
(10) Pub. No.: US 2007/0294189 A1
(43) Pub. Date: Dec. 20, 2007

(54) QUERY TOOLS

(75) Inventor: Ray Thompson, Bellevue, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/424,485

(22) Filed: Jun. 15, 2006

(51) Int. Cl. G06Q 90/00

(52) U.S. Cl. 705/36 R

(57) ABSTRACT

Methods, systems, and machine-readable media are disclosed for managing financial data associated with a plurality of financial service providers. Generally speaking, embodiments of the present invention provide tools for use in accessing a variety of financial and/or account information a large corpus of account information that may be divided among multiple database and/or systems. These tools can include, but are not limited to, a tool for providing a set of account statistics, a tool for providing a set of product control files, and/or a tool for providing a set of batch adjustment codes. In these, as well as in cooperation with other tools for searching and/or managing the information, a negative condition can be used to identify accounts or information to be excluded from a process or results.

### BACKGROUND OF THE INVENTION

Embodiments of the present invention relate generally to financial transactions. More specifically, embodiments of the present invention relate to methods and systems for managing information that is generated or accumulated in connection with financial transactions.

Databases or other collections of information of various types have grown in complexity and size. For example, financial information related to various accounts and/or transactions of one or more individuals, businesses, or other entities are commonly maintained by one or more financial institutions. This information can include, for example, accounts maintained by or related to one or more financial institutions, personal and/or transaction information related to those accounts, information for managing and/or maintaining those accounts, etc. As the size of these collections of data grow, managing the data and access to the data, searching the data, and presenting the search results or other information in a convenient and meaningful way becomes more difficult. Hence, there is a need for improved methods and systems for managing large collections of data.

### BRIEF SUMMARY OF THE INVENTION

Methods, systems, and machine-readable media are disclosed for managing financial data associated with a plurality of financial service providers. According to one embodiment, a method of managing financial data associated with a plurality of financial service providers can comprise receiving a set of criteria for identifying one or more accounts for one of the financial service providers. The criteria can specify an environment in which the financial data is stored. The environment can comprise a plurality of categories for storing the financial data. The one or more accounts can be identified based on the set of criteria in the environment specified by the criteria. In some cases, the criteria can comprise a negative condition for identifying the one or more accounts. In such a case, identifying the one or more accounts can comprise searching the financial data based on the criteria, including in a set of results accounts that contain data matching the criteria, and excluding from the set of results accounts that contain data matching the negative condition. A distribution of the accounts across one or more of the categories in the environment can be determined.

In some cases, the method can further comprise receiving an indication of a type of output for the one or more accounts. In response to the indication of the type of output indicating a summary, a summary of the accounts identified based on the criteria can be provided. In response to the indication of the type of output indicating a dump of account information, a summary of the accounts identified based on the criteria and a list of accounts in each category can be provided. In either case, the summary can indicate a distribution of accounts across the plurality of categories in the specified environment. Providing the summary of the accounts identified based on the criteria and/or providing the list of accounts in each category can comprise writing the summary and/or list of accounts in each category to a file or displaying the summary and list of accounts in each category.

According to another embodiment, a method for managing financial data associated with a plurality of financial service providers can comprise receiving a first set of criteria for identifying a first set of accounts for one of the financial service providers. The first set of criteria can specify an environment. The environment can comprise a plurality of categories for storing the financial data. A first set of one or more product control files can be read based on the criteria. Each product control file of the set of product control files can include data for controlling at least one related account of the first set of accounts. A summary of the one or more product control files can be provided. The summary can identify each product control file and one or more categories in which accounts controlled by each product control file are stored.

The method can also include receiving a second set of criteria for a second set of accounts for the one of the financial service providers. A second set of product control files can be read based on the criteria. The first set of control files can be compared with the second set of control files. A summary of comparing the first set of control files with the second set of control files can be provided. In some cases, the first set of criteria and the second set of criteria each specify an environment. In such a case, the environment specified by the first set of criteria can be different from the environment specified by the second set of set of criteria.

According to yet another embodiment, a method for managing financial data associated with a plurality of financial service providers can comprise receiving a set of criteria for identifying one or more accounts for one of the financial service providers. The criteria can identify one of the plurality of financial service providers. One or more batch adjustment codes for the financial service provider can be identified based on the criteria. The batch adjustment codes can identify functions available for adjusting at least one of the one or more accounts. A summary of the batch adjustment codes can be provided.

In some cases, the criteria can include a negative condition for locating the one or more batch adjustment codes for the financial service provider. In such a case, locating the one or more batch adjustment codes for the financial service provider can comprise searching the financial data based on the criteria, including in a set of results accounts that contain data matching the criteria, and excluding from the set of results accounts that contain data matching the negative condition.

According to still another embodiment, a system can comprise a communication network and a plurality of data stores communicatively coupled with the network. The data stores can be adapted to maintain financial account information associated with a plurality of financial service providers. The system can also include a client device communicatively coupled with the communication network and a server communicatively coupled with the communication network. The server can be adapted to receive from the client device a set of criteria for identifying one or more accounts for one of a plurality of financial service providers in the plurality of data stores, the criteria specifying an environment in which the financial data is stored, the environment comprising a plurality of categories for storing the financial data. The server can identify the one or more accounts based on the set of criteria in the environment specified by the criteria and determine a distribution of the accounts across one or more of the categories in the environment. The server can read a first set of one or more product control files based on the criteria, each product control file of the set of product control files including data for controlling at least one related account of the set of accounts and provide a summary of the one or more product control files, the summary identifying each product control file and one or more categories in which accounts controlled by each product control file are stored. The server can also locate one or more batch adjustment codes for the financial service provider based on the criteria, the batch adjustment codes identifying functions available for adjusting at least one of the one or more accounts.

### BRIEF DESCRIPTION OF THE DRAWINGS

FIG. 1 is a block diagram illustrating an exemplary environment in which embodiments of the present invention may be implemented.

FIG. 2 is an exemplary computer system upon which embodiments of the present invention may be implemented.

FIG. 3 illustrates an exemplary user interface for a query tool through which embodiments of the present invention may be implemented.

FIGS. 4A and 4B illustrate exemplary user interfaces for an account statistics function according to one embodiment of the present invention.

FIGS. 5A and 5B illustrate exemplary user interfaces for a product control file function according to one embodiment of the present invention.

FIGS. 6A and 6B illustrate exemplary user interfaces for a search for accounts function according to one embodiment of the present invention.

FIG. 7A and 7B illustrate exemplary user interfaces for a batch adjustment function according to one embodiment of the present invention.

FIG. 8 is a flowchart illustrating a process for an account statistics function according to one embodiment of the present invention.

FIG. 9 is a flowchart illustrating a process for a product control file function according to one embodiment of the present invention.

FIG. 10 is a flowchart illustrating a process for a search for accounts function according to one embodiment of the present invention.

FIG. 11 is a flowchart illustrating a process for a batch adjustment function according to one embodiment of the present invention.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the invention provide methods and systems for managing large collections of data. In some such embodiments, the processes are executed by an entity on behalf of one or more client organizations. The description below sometimes provides illustrations that use an example where a client organization is a financial institution, but there is no such requirement for the invention and the methods are intended also to be applicable to other types of organizations that make use of large collections of data. For example, embodiments of the invention may also be used for managing health-care documents or information.

The description herein sometimes refers to “clients” and to “customers.” Reference to “clients” is intended to refer to persons, i.e. individuals, entities, or their agents, on whose behalf a set of information is managed. Reference to “customers” is intended to refer to persons, i.e. individuals, entities, or their agents, who are the subject of or related to that information. Thus, merely for purposes of illustration, in the case where the information comprises credit-card account records for a credit card issued to Mr. Jones by Bank A, Bank A corresponds to a client and Mr. Jones corresponds to a customer.

Generally speaking, embodiments of the present invention provide tools for use in accessing a variety of financial and/or account information a large corpus of account information that may be divided among multiple database and/or systems. These tools can include, but are not limited to, a tool for providing a set of account statistics, a tool for providing a set of product control files, and/or a tool for providing a set of batch adjustment codes. In these, as well as in cooperation with other tools for searching and/or managing the information, a negative condition can be used to identify accounts or information to be excluded from a process or results.

According to one embodiment of the present invention, a method of managing financial data associated with a plurality of financial service providers, i.e., a tool for providing account statistics, can comprise receiving a set of criteria for identifying one or more accounts for one of the financial service providers. The criteria can specify an environment in which the financial data is stored. The environment can comprise a plurality of categories for storing the financial data. The one or more accounts can be identified based on the set of criteria in the environment specified by the criteria. A distribution of the accounts across one or more of the categories in the environment can be determined.

According to another embodiment of the present invention, a method for managing financial data associated with a plurality of financial service providers, i.e., a tool for providing a set of product control files, can comprise receiving a first set of criteria for identifying a first set of accounts for one of the financial service providers. The first set of criteria can specify an environment. The environment can comprise a plurality of categories for storing the financial data. A first set of one or more product control files can be read based on the criteria. Each product control file of the set of product control files can include data for controlling at least one related account of the first set of accounts. A summary of the one or more product control files can be provided. The summary can identify each product control file and one or more categories in which accounts controlled by each product control file are stored.

According to yet another embodiment of the present invention, a method for managing financial data associated with a plurality of financial service providers, i.e., a tool for providing a set of batch adjustment codes, can comprise receiving a set of criteria for identifying one or more accounts for one of the financial service providers. The criteria can identify one of the plurality of financial service providers. One or more batch adjustment codes for the financial service provider can be identified based on the criteria. The batch adjustment codes can identify functions available for adjusting at least one of the one or more accounts. A summary of the batch adjustment codes can be provided.

In each case, as well as when performing searches or other management functions, the criteria can include a negative condition for locating the account or other information. In such a case, locating the information can comprise searching the financial data based on the criteria, including in a set of results accounts that contain data matching the criteria, and excluding from the set of results accounts that contain data matching the negative condition.

Each of these tools may be implemented individually or in combination with these or other tools for managing a collection of financial or other data. For example, these tools are thought to be especially useful when integrated in a query tool such as provided by First Data Corporation for accessing, searching, and managing financial data provided by one or more clients related to any number of customers. While embodiments of the present invention are discussed below and illustrated in the context of such a query tool, it should be understood that this context is offered for illustrative purposes only and is not intended to be limiting. Other implementations are contemplated and considered to be within the scope of the present invention.

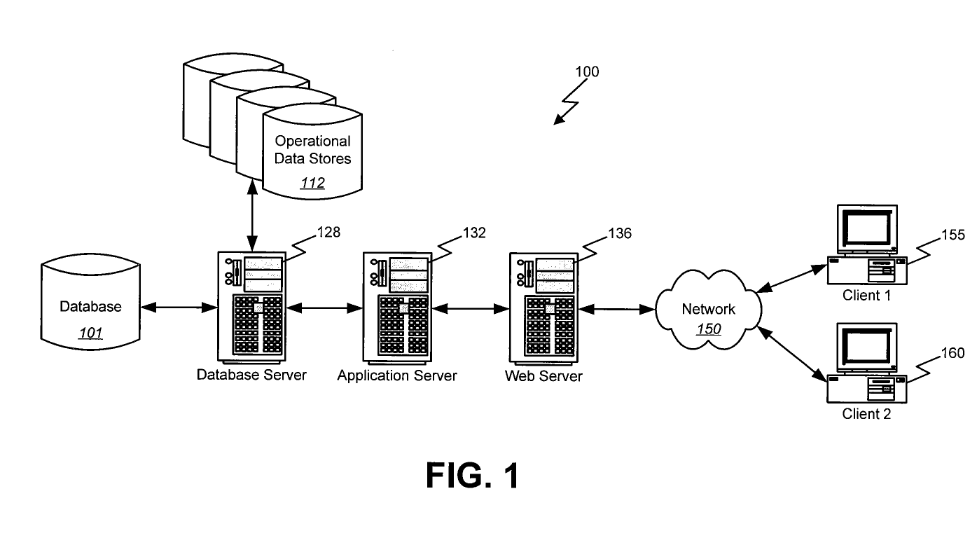

FIG. 1 is a block diagram illustrating an exemplary environment in which embodiments of the present invention may be implemented. In this example, the system 100 can include a database 101 and/or one or more operational data stores 112. The database 101 and/or operational data stores 112 may comprise information collected from or on behalf of such entities as banks, credit unions, trust-management companies, mutual fund companies, discount brokerage firms, and the like. For example, the information can include accounts numbers, balances, transaction records, personal records, etc. for any number of customer accounts associated with any number of financial institutions or other clients.

Generally speaking, the system 100, as illustrated in FIG. 1, provides an interface with the database 101 and/or data stores 112. Financial-service providers or other clients 155 and 160 that wish to access or perform an analysis based on the data maintained in the database 101 can interface with a web server 136 via a network 150. The network 150 may can be any type of network familiar to those skilled in the art that can support data communications using any of a variety of commercially-available protocols, including without limitation TCP/IP, SNA, IPX, AppleTalk, and the like. Merely by way of example, the network 150 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks.

The web server 136 is itself in communication with an application server 132. The application server 132 communicates with a database server 128 that performs the actual extraction of data. The application server 132 can be configured to execute functions that a user from the financial-service provider may specify through the web server 136. Importantly, while illustrated here as separate servers, the functions of the web server 136, application server 132, and database server may alternatively be implemented in any number of one or more servers.

A number of types of functions may be accessed by the clients 155 and 160 through the web server 136, application server 132 and database server 128. For example, the web server 136 may permit the clients 155 and 166 to prepare a specialized query of the database 101 in which the criteria that define what data is extracted from the database 101 are defined on a case-by-case basis by the user. In some other embodiments, a query may be selected from a menu of preformatted queries. In some embodiments, a mechanism can be provided for allowing queries to be executed on a scheduled basis, such as weekly or monthly. The specialized queries or other functions can include, but are not limited to, a tool for providing a set of account statistics, a tool for providing a set of product control files, and/or a tool for providing a set of batch adjustment codes, etc. Details of each of these tools will be discussed further below.

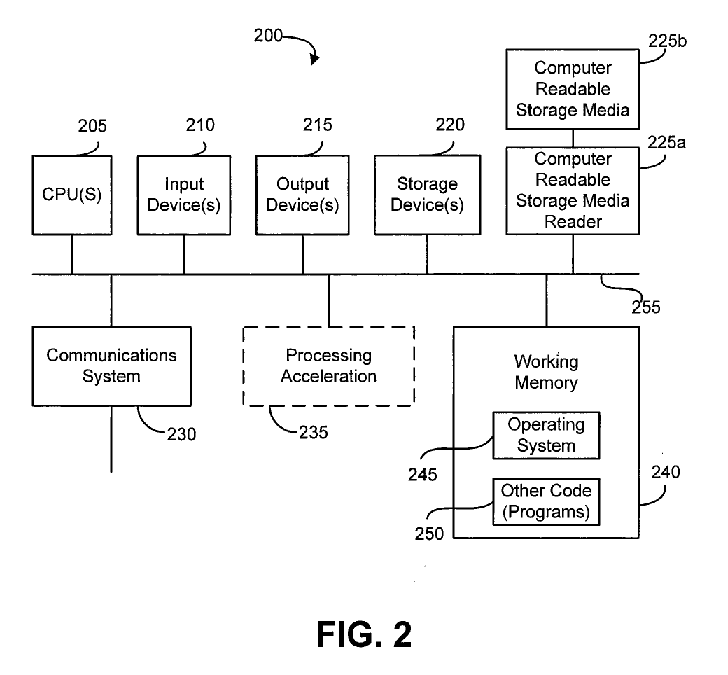

FIG. 2 is an exemplary computer system upon which embodiments of the present invention may be implemented. The computer system 200 is shown comprising hardware elements that may be electrically coupled via a bus 255. The hardware elements may include one or more central processing units (CPUs) 205; one or more input devices 210 (e.g., a scan device, a mouse, a keyboard, etc.); and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225; a communications system 230 (e.g., a modem, a network card (wireless or wired), an infra-red communication device, etc.); and working memory 240, which may include RAM and ROM devices as described above. In some embodiments, the computer system 2000 may also include a processing acceleration unit 235 , which can include a DSP, a special-purpose processor and/or the like.

The computer-readable storage media reader 225 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with a network and/or any other computer or other type of device.

The computer system 200 may also comprise software elements, shown as being currently located within a working memory 240, including an operating system 245 and/or other code 250, such as an application program. The application programs may implement components of a strategic communications system, and/or the methods of the invention. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

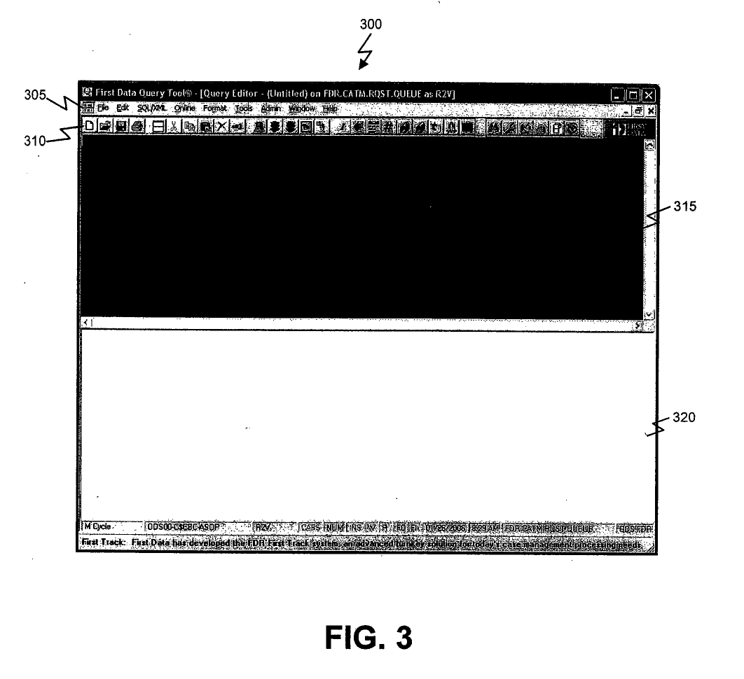

FIG. 3 illustrates an exemplary user interface for a query tool in which embodiments of the present invention may be implemented. This example illustrates an interface that may be presented to a client accessing a web server via a web browser to search or otherwise access a set of information maintained in a database as discussed above with reference to FIG. 1. More specifically, this example illustrates the main window 300 of the First Data Query Tool through which embodiments of the present invention may be implemented. However, as noted above, it should be understood that this context is offered for illustrative purposes only and is not intended to be limiting. Other implementations are contemplated and considered to be within the scope of the present invention.

In this example, the main window 300 of the query tool includes two frames 315 and 320. As will be seen, the top frame 315 can be used to display user input when the tool is used in a terminal emulation mode. The bottom frame 320 can be used to display results of various searches or other operations performed at the user's request or direction. The window 300 also includes a drop-down menu bar 305 and a tool bar 310. The menu bar 305 and tool bar 310 can provide a number of textual and graphical indications of tools, functions, operations, etc. that can be initiated or performed through query tool. For example, menu bar 305, tool bar 310, or both may contain a menu selection or tool icon for initiating a search, obtaining a set of account statistics, accessing a set of product control files, obtaining a set of batch adjustment codes, etc.

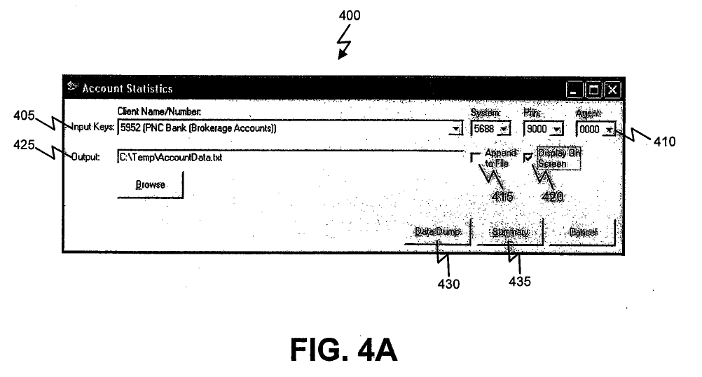

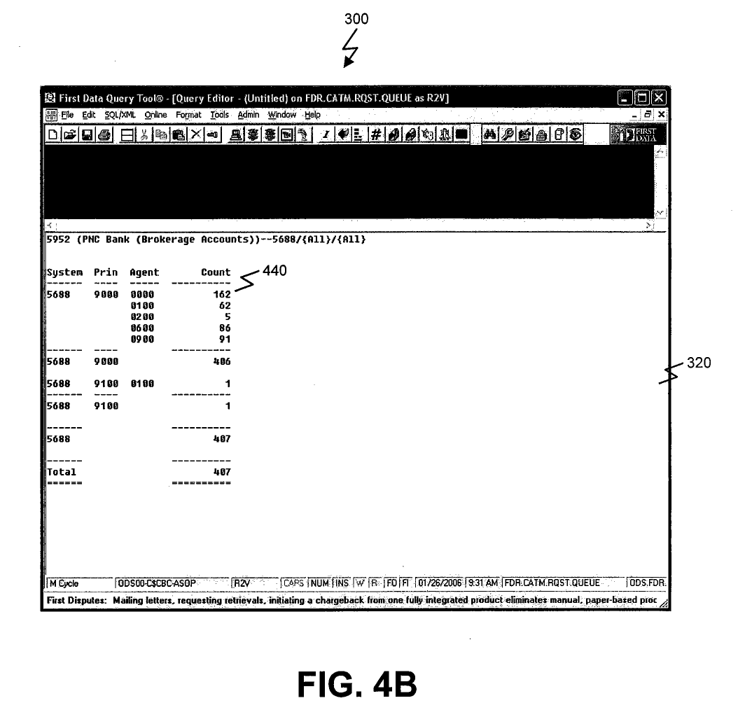

FIGS. 4A and 4B illustrate exemplary user interfaces for an account statistics function according to one embodiment of the present invention. The example of FIG. 4A illustrates a pop-up window or dialog box 400 as may be presented when a user selects a corresponding menu bar or tool bar selection. The dialog box can include a text box 405 for entering an indication of the client for which the statistics are to be gathered. The dialog box also includes a set of drop down-boxes 410 for designating a category to be searched. In this example, the categories are designated by “system,” “prin,” and “agent,” each of which may be used to store information related to the designated client.

The dialog box also includes a number of buttons 430 and 435 for starting the account statistics function for the designated client in the designated categories. The buttons can include, among other possibilities, a data dump button 430 and a summary button 435. According to one embodiment of the present invention, selection of the summary button 435 can cause output of a summary of account statistics for the designated categories of the designated clients including a distribution of the account information across the categories. Selection of the data dump button can cause output not only of summary of account statistics for the designated categories of the designated clients including a distribution of the account information across the categories, but also a list of account number stored in each category. Examples of such an output are discussed below with references to FIG. 4B.

The dialog box 400 can also include another textbox 425 and one or more checkboxes 415 and 420, radio buttons, or other elements for designating a type and/or location for the output. For example, a user may select one checkbox 420 to have either the summary or data dump output to a video display or monitor. Another checkbox 415 may be selected to have either the summary or the data dump output to a file or other destination designated in the output destination textbox 425.

FIG. 4B illustrates exemplary results of the account summary operation. In this example, the results are displayed in the main window 300 of the query tool illustrated in FIG. 3. More specifically, the results 440 can be displayed in the bottom frame 320 of the window 300. The results 440 can include, as shown in this example, a summary of each category found matching the users criteria entered via the dialog box of FIG. 4A and a distribution or count of the number of accounts in each category. Alternatively, if so selected by the user, the results 440 could also include a list of all account number in each category.

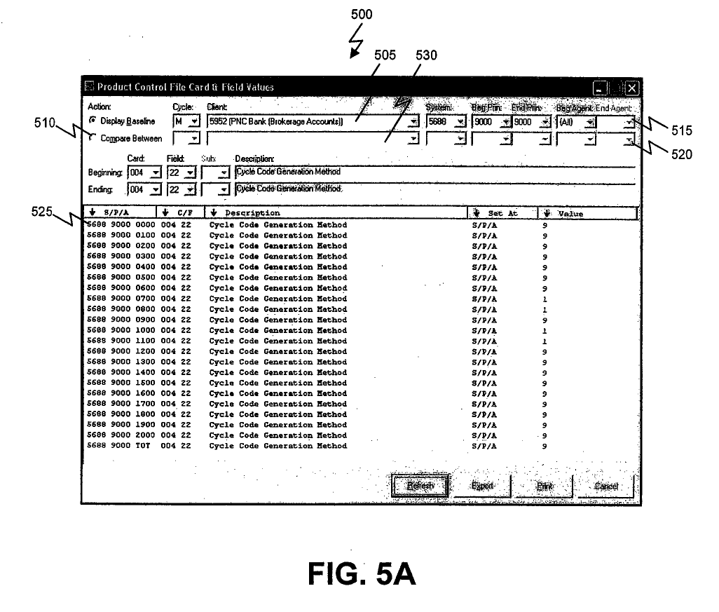

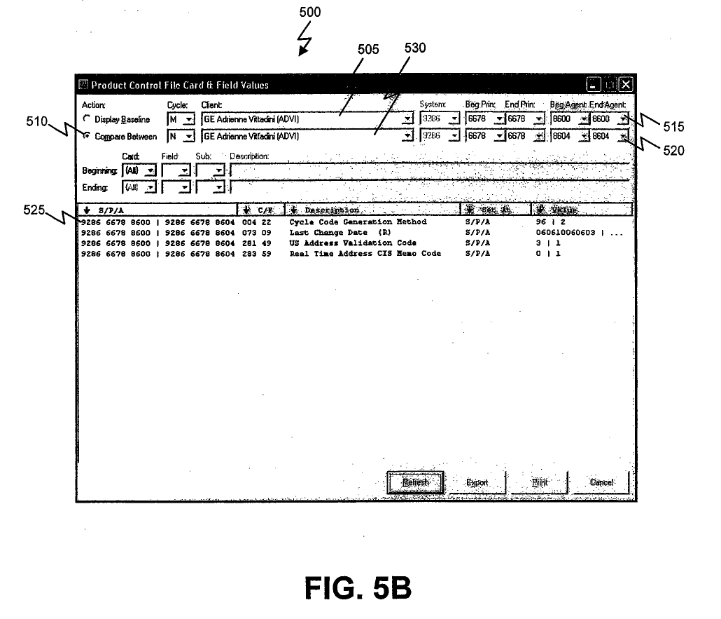

FIGS. 5A and 5B illustrate exemplary user interfaces for a product control file function according to one embodiment of the present invention. More specifically, FIG. 5A includes a dialog box 500 with a number of elements for entering criteria for finding product control files. As introduced above, production control files can be used by the system maintaining the financial data for the clients to control how this information is processed or maintained by the system. The product control file function allows a client to identify product control files for a designated category.

So, the dialog box 500 can include a textbox for entering an indication of the client for which product control files will be found and a set of drop-down boxes 515 for designating which categories will be searched. Again, the categories are designated by “system,” “prin,” and “agent,” each of which may be used to store information related to the designated client. Results 525 showing the product control files for each category can also displayed in the dialog box 500 or separately in another window, file, report, etc.

According to one embodiment of the present invention, the dialog box 500 can also include another text box 530 and set of drop-down boxes 520 for inputting a second set of categories to be searched. In such a case, a radio button 510 or other control may be used to designate a comparison function to be performed between the first set of product control files and the second set of product control files. So, for example, a user may perform a comparison of product control files between multiple environments. This may be especially useful in debugging when comparisons between a test environment and a production environment can be used to find incorrect or inconsistent settings.

FIG. 5B illustrates an exemplary interface for illustrating such a comparison. In this example, a second set of categories to be searched has been entered in text box 530 and set of drop-down boxes 520. Radio button 510 has also been selected to designate a comparison function to be performed between the first set of product control files and the second set of product control files. Furthermore, a set of results 525 can be displayed for the comparison. That is, based on the criteria entered via the dialog box 500, a number of product control files can be compared between categories, environments, etc. and matching product control files can be displayed in a tabular, textual form. Of course other formats, such as a graphical or other textual arrangement are contemplated and are considered to be within the scope of the present invention.

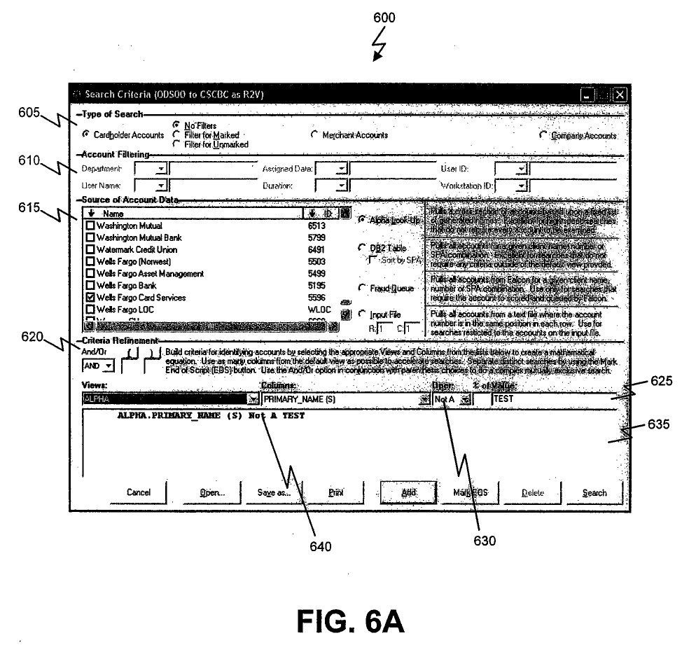

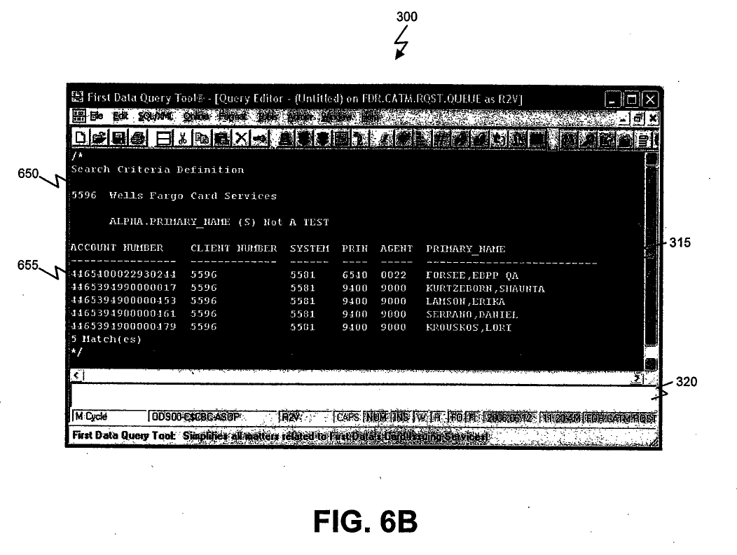

FIGS. 6A and 6B illustrate exemplary user interfaces for a search for accounts function according to one embodiment of the present invention. More specifically, FIG. 6A includes a dialog box 600 with a number of elements for entering criteria for searching for account information. The dialog box can have a number of sections 605-620 which include, but are not limited to, a type of search section 605, an account filtering section 610, a source section 615, and a criteria refinement section 620. The type of search section 605 can include a number of radio buttons, as shown here, or other elements for selecting or specifying a type of search to be performed such as searching for cardholder accounts, merchant accounts, etc. The account filtering section 610 can include a number of textboxes, combo boxes, or other elements for selecting or specifying additional filters to be applied to the search. The source section 615 can include a number of checkboxes, radio buttons, textboxes and/or other elements to select or specify, by name, location, or other criteria, a source for the account information to be searched. The criteria refinement section 620 can include a number of textboxes, combo boxes, or other elements for selecting or specifying additional criteria for refining the search. For example, a set of combo boxes 625 can be used to specify columns to be searched, logical operations to be performed, a value to be searched for, etc. Additionally or alternatively, the criteria refinement section can include a textbox 635 for entering search criteria or editing criteria selected via the combo boxes 625 or other elements, if any. In this example, the combo boxes 625 provide a selection of a negative condition in the operation box 630. Additionally, this example allows entry of such a negative condition 640 in the textbox. The negative condition 640 can be applied to find accounts that otherwise match the search criteria but exclude those that match the negative condition 640.

FIG. 6B illustrates exemplary results of a search. In this example, the results 655 are displayed in the main window 300 of the query tool. More specifically, the upper frame 315 of the main window can display the search criteria 650 entered by the user and the results 655 in a tabular, textual form. Of course other formats, such as a graphical or other textual arrangement are contemplated and are considered to be within the scope of the present invention.

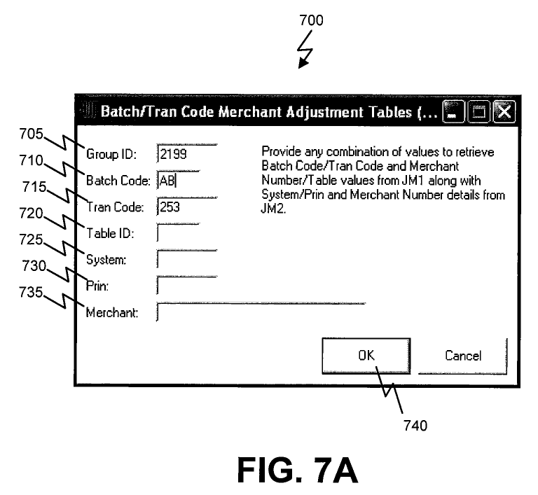

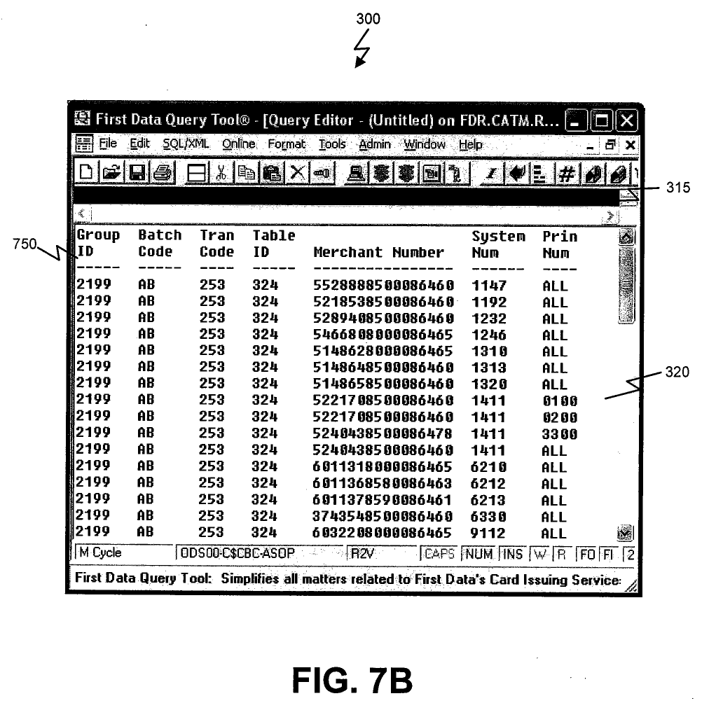

FIG. 7A and 7B illustrate an exemplary user interface for a batch adjustment function according to one embodiment of the present invention. More specifically, FIG. 7A includes a dialog box 700 with a number of elements for entering criteria for locating accounts, groups, etc. having a particular batch code, the batch adjustment codes can identify functions available for adjusting at least one of the one or more accounts. Locating the batch adjustment codes can comprise searching the financial data to locate data matching the criteria designated by the requesting user, i.e., data for the designated client and stored in the designated categories. Therefore, the dialog box can include a number of text boxes 705-735 or other elements for entering or specifying the criteria to be used for identifying accounts. These criteria can include, but are not limited to a group ID 705, a batch code 710, a trans code 715, a table ID 720, a “system” 725, a “prin” 730, a merchant 735, and/or other criteria. The dialog box 700 can also include a button 740 or other control for initiating the search.

FIG. 7B illustrates exemplary results of a search. In this example, the results 750 are displayed in the main window 300 of the query tool. More specifically, the lower frame 320 of the main window 300 can display the results 750 in a tabular, textual form. Of course other formats, such as a graphical or other textual arrangement are contemplated and are considered to be within the scope of the present invention.

It should be noted that the preceding user interfaces have been offered by way of example and not limitation. Rather, any of a variety of possible textual and/or graphical interfaces may be implemented without departing from the scope of the present invention. For example, in some cases, a purely textual interface, such as used with a terminal emulator, may be used. In other cases, various other formats, either textual, graphical, or some combination thereof may be used.

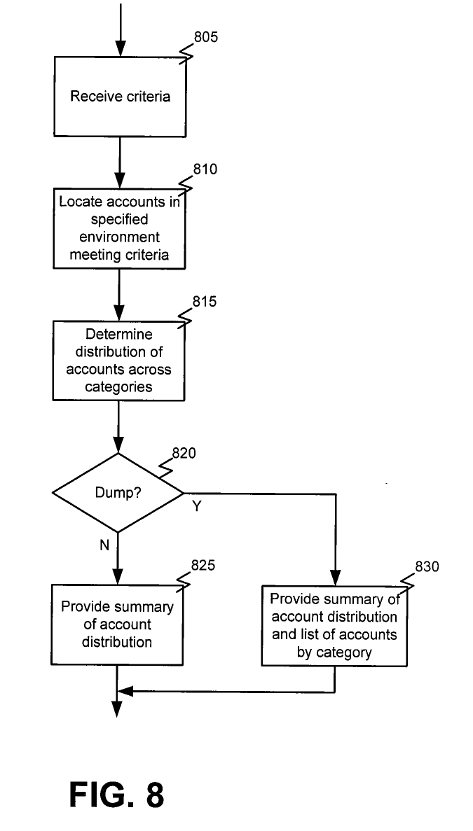

FIG. 8 is a flowchart illustrating a process for an account statistics function according to one embodiment of the present invention. In this example, the process begins with receiving 805 a set of criteria for identifying one or more accounts for one of the financial service providers. As noted above, the criteria can specify an environment in which the financial data is stored. Furthermore, the environment can comprise a plurality of categories for storing the financial data.

The one or more accounts can be identified 810 based on the set of criteria in the environment specified by the criteria. That is a search can be performed on the financial data to locate data matching the criteria designated by the requesting user, i.e., data for the designated client and stored in the designated categories.

Once the financial data matching the designated criteria is identified 810 a distribution of the accounts across one or more of the categories in the environment can be determined 815. That is, a number of accounts found in each category matching the user designated criteria can be determined. As noted above, the criteria can comprise a negative condition for identifying the one or more accounts. In such a case, identifying 810 the one or more accounts can comprise searching the financial data based on the criteria, including in a set of results accounts that contain data matching the criteria, and excluding from the set of results accounts that contain data matching the negative condition.

A determination 820 can be made as to the format of the output. That is, an indication of a type of output for the one or more accounts can be received. For example, as discussed above, the user may select a summary output showing the account distribution or may select a dump of account numbers by category. In response to determining 820 the indication of the type of output is a summary, a summary of the accounts identified based on the criteria can be provided 825. As noted above, the summary can indicate a distribution of accounts across the plurality of categories in the specified environment. In response to determining 820 that the indication of the type of output indicates a dump of account information, a summary of the accounts identified based on the criteria and a list of accounts in each category can be provided. In either case, providing a summary of the accounts and/or list of accounts identified based on the criteria can comprise writing the summary and/or list of accounts to a file, displaying the summary and/or list on a video display or screen, etc.

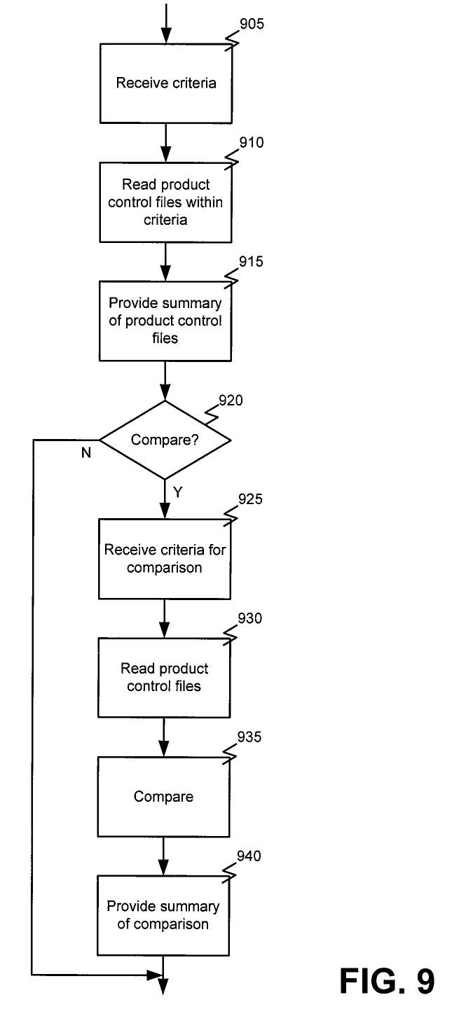

FIG. 9 is a flowchart illustrating a process for a product control file function according to one embodiment of the present invention. In this example, the process begins with receiving 905 a first set of criteria for identifying a first set of accounts for one of the financial service providers. The first set of criteria can specify an environment. The environment can comprise a plurality of categories for storing the financial data.

A first set of one or more product control files can be read 910 based on the criteria. As noted above, each product control file of the set of product control files can include data for controlling at least one related account of the first set of accounts. Reading 910 a first set of one or more product control files based on the criteria can comprise searching the financial data to locate data matching the criteria designated by the requesting user, i.e., data for the designated client and stored in the designated categories. As noted above, the criteria further can comprise a negative condition for reading the first set of one or more product control files. In such a case, reading the first set of one or more product control files can comprises searching the financial data based on the criteria, including in a set of results accounts that contain data matching the criteria, and excluding from the set of results accounts that contain data matching the negative condition.

A summary of the one or more product control files can be provided 915. The summary can identify each product control file and one or more categories in which accounts controlled by each product control file are stored. Providing a summary can comprise writing the summary to a file, displaying the summary on a video display or screen, etc.

According to one embodiment, a determination 920 can be made as to whether a comparison is indicated or requested. In response to determining 920 that a comparison is requested, a second set of criteria for a second set of accounts for the one of the financial service providers can be received 925. The first set of criteria and the second set of criteria can each specify an environment. Furthermore, the environment specified by the first set of criteria can be different from the environment specified by the second set of set of criteria. Therefore, the user can request a comparison, for example, of a test environment to a production environment for debugging or other purposes.

A second set of product control files can be read 930 based on the criteria. As noted above, the criteria can comprise a negative condition for reading the second set of product control files. In such a case, reading the second set of product control files can comprise searching the financial data based on the criteria, including in a set of results accounts that contain data matching the criteria, and excluding from the set of results accounts that contain data matching the negative condition.

The first set of control files can then be compared 935 with the second set of control files. A summary of comparing the first set of control files with the second set of control files can then be provided. Providing a summary can comprise writing the summary to a file, displaying the summary on a video display or screen, etc.

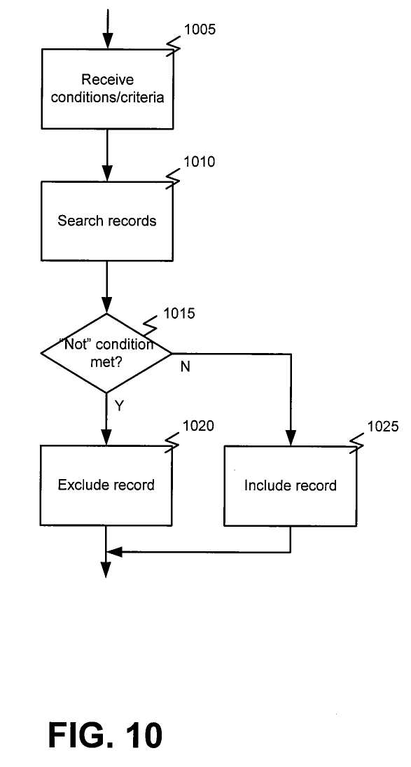

FIG. 10 is a flowchart illustrating a process for a search for accounts function according to one embodiment of the present invention. In this example, the process begins with receiving 1005 a first set of criteria for identifying a first set of accounts for one of the financial service providers. The first set of criteria can specify an environment. The environment can comprise a plurality of categories for storing the financial data.

A first set of records can be read 1010 based on the criteria. As noted above, the criteria further can comprise a negative condition for reading the first set of records. Therefore, a determination 1015 can be made as to whether the negative condition is met. In response to determining 1015 the negative condition is not met, a set of results can be determined 1025 that includes data matching the criteria. In response to determining 1015 the negative condition is met, a set of results can be determined 1020 that excludes data matching the negative criteria.

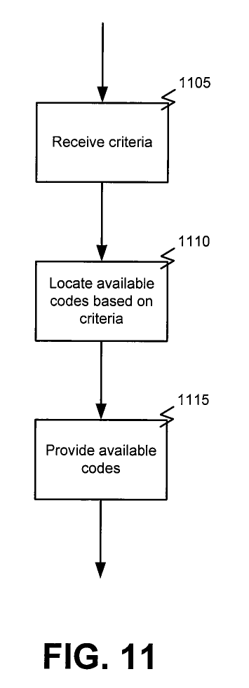

FIG. 11 is a flowchart illustrating a process for a batch adjustment function according to one embodiment of the present invention. In this example, the process begins with receiving 1105 a set of criteria for identifying one or more accounts for one of the financial service providers. As noted above, the criteria can identify one of the plurality of financial service providers.

One or more batch adjustment codes can be located 1110 for the financial service provider based on the criteria. As noted above, the batch adjustment codes can identify functions available for adjusting at least one of the one or more accounts. Locating the batch adjustment codes can comprise searching the financial data to locate data matching the criteria designated by the requesting user, i.e., data for the designated client and stored in the designated categories. Also as noted above, the criteria can comprise a negative condition for locating the one or more batch adjustment codes for the financial service provider. In such a case, locating the one or more batch adjustment codes for the financial service provider can comprise searching the financial data based on the criteria, including in a set of results accounts that contain data matching the criteria, and excluding from the set of results accounts that contain data matching the negative condition.

A summary of the batch adjustment codes can be provided 1115. Providing a summary can comprise writing the summary to a file, displaying the summary on a video display or screen, etc.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for managing financial data associated with a plurality of financial service providers, the method comprising:
receiving a set of criteria for identifying one or more accounts for one of the financial service providers, the criteria specifying an environment in which the financial data is stored, the environment comprising a plurality of categories for storing the financial data;
identifying the one or more accounts based on the set of criteria in the environment specified by the criteria; and
determining a distribution of the accounts across one or more of the categories in the environment.

2. The method of claim 1, further comprising receiving an indication of a type of output for the one or more accounts.

3. The method of claim 2, further comprising in response to the indication of the type of output indicating a summary, providing a summary of the accounts identified based on the criteria, wherein the summary indicates a distribution of accounts across the plurality of categories in the specified environment.

4. The method of claim 3, wherein providing a summary of the accounts identified based on the criteria comprises writing the summary to a file.

5. The method of claim 3, wherein providing a summary of the accounts identified based on the criteria comprises displaying the summary.

6. The method of claim 2, further comprising in response to the indication of the type of output indicating a dump of account information, providing a summary of the accounts identified based on the criteria, wherein the summary indicates a distribution of accounts across the plurality of categories in the specified environment and providing a list of accounts in each category.

7. The method of claim 6, wherein providing the summary of the accounts identified based on the criteria and providing the list of accounts in each category comprises writing the summary and list of accounts in each category to a file.

8. The method of claim 6, wherein providing the summary of the accounts identified based on the criteria and providing the list of accounts in each category comprises displaying the summary and list of accounts in each category.

9. The method of claim 1, wherein the criteria further comprises a negative condition for identifying the one or more accounts.

10. The method of claim 9, wherein identifying the one or more accounts comprises searching the financial data based on the criteria, including in a set of results accounts that contain data matching the criteria, and excluding from the set of results accounts that contain data matching the negative condition.

11. A method for managing financial data associated with a plurality of financial service providers, the method comprising:
receiving a first set of criteria for identifying a first set of accounts for one of the financial service providers, the first set of criteria specifying an environment, the environment comprising a plurality of categories for storing the financial data;
reading a first set of one or more product control files based on the criteria, each product control file of the set of product control files including data for controlling at least one related account of the first set of accounts;
providing a summary of the one or more product control files, the summary identifying each product control file and one or more categories in which accounts controlled by each product control file are stored.

12. The method of claim 11, wherein the criteria further comprises a negative condition for reading the first set of one or more product control files.

13. The method of claim 12, wherein reading the first set of one or more product control files comprises searching the financial data based on the criteria, including in a set of results accounts that contain data matching the criteria, and excluding from the set of results accounts that contain data matching the negative condition.

14. The method of claim 11, further comprising:
receiving a second set of criteria for a second set of accounts for the one of the financial service providers;
reading a second set of product control files based on the criteria; and
comparing the first set of control files with the second set of control files.

15. The method of claim 14, wherein the criteria further comprises a negative condition for reading the second set of product control files.

16. The method of claim 15, wherein reading the second set of product control files comprises searching the financial data based on the criteria, including in a set of results accounts that contain data matching the criteria, and excluding from the set of results accounts that contain data matching the negative condition.

17. The method of claim 14, wherein the first set of criteria and the second set of criteria each specify an environment.

18. The method of claim 17, wherein the environment specified by the first set of criteria is different from the environment specified by the second set of set of criteria.

19. The method of claim 14, further comprising providing a summary of comparing the first set of control files with the second set of control files.

20. A method for managing financial data associated with a plurality of financial service providers, the method comprising:
receiving a set of criteria for identifying one or more accounts for one of the financial service providers, the criteria identifying one of the plurality of financial service providers;
locating one or more batch adjustment codes for the financial service provider based on the criteria, the batch adjustment codes identifying functions available for adjusting at least one of the one or more accounts.

21. The method of claim 20, further comprising providing a summary of the batch adjustment codes

22. The method of claim 20, wherein the criteria further comprises a negative condition for locating the one or more batch adjustment codes for the financial service provider.

23. The method of claim 22, wherein locating the one or more batch adjustment codes for the financial service provider comprises searching the financial data based on the criteria, including in a set of results accounts that contain data matching the criteria, and excluding from the set of results accounts that contain data matching the negative condition.

24. A system comprising:
a communication network;
a plurality of data stores communicatively coupled with the network and adapted to maintain financial account information associated with a plurality of financial service providers;
a client device communicatively coupled with the communication network; and
a server communicatively coupled with the communication network and adapted to receive from the client device a set of criteria for identifying one or more accounts for one of a plurality of financial service providers in the plurality of data stores, the criteria specifying an environment in which the financial data is stored, the environment comprising a plurality of categories for storing the financial data, identify the one or more accounts based on the set of criteria in the environment specified by the criteria and determining a distribution of the accounts across one or more of the categories in the environment, read a first set of one or more product control files based on the criteria, each product control file of the set of product control files including data for controlling at least one related account of the set of accounts and providing a summary of the one or more product control files, the summary identifying each product control file and one or more categories in which accounts controlled by each product control file are stored, and locate one or more batch adjustment codes for the financial service provider based on the criteria, the batch adjustment codes identifying functions available for adjusting at least one of the one or more accounts.
